(19) United States
(12) Patent Application Publication
(10) Pub. No.: US 2024/0392897 A1
(43) Pub. Date: Nov. 28, 2024

(54) DESERT-SAND ENGINEERED CEMENTITIOUS COMPOSITE PIPES

(71) Applicants: Saudi Arabian Oil Company, Dhahran (SA); University of Michigan, Ann Arbor, MI (US)

(72) Inventors: Georgios Zapsas, Dhahran (SA); Victor C. Li, Ann Arbor, MI (US); He Zhu, Ann Arbor, MI (US); Waleed Al Nasser, Dammam (SA); Mohammed Mehthel, Dhahran (SA); Oscar Salazar Vidal, Dhahran (SA); Muhammad Aamer Bhutta, Khobar (SA); Thibault Villette, Belfort (FR)

(73) Assignees: Saudi Arabian Oil Company, Dhahran (SA); University of Michigan, Ann Arbor, MI (US)

(21) Appl. No.: 18/670,837

(22) Filed: May 22, 2024

Related U.S. Application Data
(60) Provisional application No. 63/503,600, filed on May 22, 2023.

(51) Int. Cl. F16L 9/08; C04B 14/06; C04B 14/14; C04B 16/06; C04B 18/08; C04B 18/14; C04B 18/22; C04B 28/04; C04B 103/30; C04B 111/56

(52) U.S. Cl. CPC F16L 9/085; C04B 14/068; C04B 14/14; C04B 16/0633; C04B 18/08; C04B 18/146; C04B 18/22; C04B 28/04; C04B 2103/302; C04B 2111/56

(57) ABSTRACT

A pipe includes a tubular body made entirely of a desert sand engineered cementitious composite (DSECC) made with a cement binder, unprocessed desert sand, and polymer fibers selected from polyethylene fibers, polypropylene fibers, and a combination thereof. The tubular body has a wall with a thickness that is less than 22 percent of an inner diameter of the pipe. The pipe is fully non-metallic.

### BACKGROUND

Due to its very low tensile strength, conventional concrete is susceptible to cracking caused by imposed deformations and loads. Cracks jeopardize structural durability, especially when exposed to water, such as in pipes. Water and corrosive ions penetrate cracks, causing further deterioration of the concrete structure.

To provide the required reliability and longevity needed in pipes, especially pipes used for infrastructure projects such as storm or sanitary sewer conduits, concrete pipes include a reinforcement member cast in place within the concrete wall of the pipe. Such pipes are referred to as reinforced concrete pipes (RCP).

Reinforcement members in RCP are typically made from steel. Additionally, reinforcement members may form a generally tubular frame, which may be concentrically nested within a concrete wall of an RCP. Standard RCP are available with diameters ranging from 12 inches to 12 feet, and may have a circular cross-sectional profile or non-circular (e.g., elliptical or arched) profiles. Reinforcement members in RCP provide support and improved strength in the RCP that allow such pipe to be used in typical infrastructure projects for long life cycles.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to pipes having a tubular body made entirely of a desert sand engineered cementitious composite (DSECC) including a cement binder, unprocessed desert sand, and polymer fibers selected from polyethylene fibers, polypropylene fibers, and a combination thereof. The tubular body may have a wall with a uniform thickness that is less than 22 percent of an inner diameter of the pipe.

Additionally, the DSECC pipe may be fully non-metallic and made without a reinforcement member.

In another aspect, embodiments disclosed herein relate to a DSECC composition that may be designed for forming pipes made without a reinforcement member.

Other aspects and advantages of the claimed subject matter will be apparent from the following description and the appended claims.

### BRIEF DESCRIPTION OF DRAWINGS

FIGS. 1A-1E show stress-strain graphs comparing performance of a reference composition made without desert sand to DSECC compositions according to embodiments of the present disclosure. Each figure reflects the test of three specimens.

FIG. 2 shows a DSECC pipe according to embodiments of the present disclosure.

FIG. 3 shows a DSECC pipe connection according to embodiments of the present disclosure.

FIG. 4 shows a DSECC pipe connection according to embodiments of the present disclosure.

FIGS. 5A and 5B show cross-sectional views of a conventional RCP pipe and a DSECC pipe according to embodiments of the present disclosure.

FIGS. 6A and 6B show results of a loading test comparing a conventional RCP to a DSECC pipe according to embodiments of the present disclosure.

FIG. 7 shows a water-fill test of a load-tested DSECC pipe according to embodiments of the present disclosure.

### DETAILED DESCRIPTION

In one aspect, embodiments disclosed herein relate to pipes formed entirely of a desert-sand engineered cementitious composite (DSECC), without the use of a metallic reinforcement member (e.g., without the use of a steel reinforcement frame). Thus, DSECC pipes according to embodiments disclosed herein may be fully non-metallic. In another aspect, embodiments disclosed herein relate to DSECC compositions that includes a cement binder, unprocessed desert sand, and polymer fibers, where the composition is designed for use in pipes made without reinforcement members.

### DSECC Compositions

In one aspect, embodiments disclosed herein relate to ECC compositions made with desert-sand, referred to herein as DSECC. DSECC compositions herein may include a cement binder, desert sand, and at least one type of polymeric fibers. Such compositions may optionally include one or more of fly ash, volcanic ash, silica fume, and crumb rubber. As described more below, the component compositions and amounts may be selected to provide the strength and durability necessary to form DSECC pipes that are fully non-metallic for use in infrastructure applications that would otherwise use RCP.

A cement binder for use in DSECC compositions may include any material that when mixed with water can be cured into a cement. The cement binder may be hydraulic or nonhydraulic. Suitable cement binders include, but are not limited to, ordinary Portland cement, Saudi cement, calcium solphoaluminate cement, and cements made from a mixture of lime, gypsum, plasters, and oxychloride. In particular embodiments, the cement binder is ordinary Portland cement.

DSECC compositions may include a cement binder in an amount ranging from 14 to 45 wt %, based on the total weight of the DSECC. For example, in one or more embodiments, a DSECC composition includes a cement binder in an amount ranging from a lower limit of one of 14, 15, 16, 17, 18, 19, and 20 wt % to an upper limit of one of 25, 30, 32, 35, 40, and 45 wt % of the DSECC composition, where any lower limit may be paired with any mathematically compatible upper limit.

In one or more embodiments, DSECC compositions include fibers. The fibers may be polymeric fibers. For example, DSECC compositions in accordance with the present disclosure may include polyethylene (PE) fibers, such as ultra-high molecular weight (or high modulus) polyethylene (UHMWPE) fibers. In some embodiments, DSECC compositions include a combination of PE fibers and polypropylene (PP) fibers. Additionally, fibers in a DSECC composition may have micro-scale sizes, and thus be referred to as microfibers. For example, PE and PP microfibers may have a diameter less than 300 μm.

In one or more embodiments, PE fibers are present in a DSECC composition in an amount ranging from 0.1 to 1.5 wt % (weight percent), based on the total weight of the DSECC. For example, DSECC compositions may include UHMWPE fibers in an amount ranging from a lower limit of one of 0.1, 0.2, 0.3, 0.4, and 0.5 wt % to an upper limit of one of 0.6, 0.8, 1.0, 1.1, and 1.5 wt %, where any lower limit may be paired with any mathematically compatible upper limit.

In embodiments in which the DSECC composition includes a mixture of PE fibers and PP fibers, the PP fibers may be present in the composition in an amount ranging from 0.1 to 1.0 wt %, based on the total weight of the DSECC. For example, DSECC compositions may include PP fibers in an amount ranging from a lower limit of one of 0.1, 0.2, 0.3, and 0.4 wt % to an upper limit of one of 0.5, 0.7, and 1.0 wt %, where any lower limit may be paired with any mathematically compatible upper limit. DSECC compositions that include UHMWPE fibers and PP fibers may include the fibers in a ratio ranging from 10:1 to 1:10, depending on the desired properties of the DSECC. For example, UHMWPE and PP fibers may be provided in a ratio of 10:9 or 1:1.

In one or more embodiments, DSECC compositions include sand. The sand may be desert sand. In particular, the desert sand may be unrefined (unprocessed) desert sand. As used herein, “unprocessed desert sand” means desert sand that is used directly after collection from a natural environment without any purification or processing. Suitable desert sand may come from various natural environments, including Saudi Arabia, China, and countries in Africa, among others. In some embodiments, an DSECC composition may include unprocessed desert sands from more than one native environment. In particular embodiments, a DSECC composition may include unprocessed desert sands from three or more native environments.

Desert sand may have physical properties that differ from prepared silica sand such as morphology, uniformity, average particle size, and particle size distribution. For example, desert sand included in DSECC compositions may have a much larger particle size and particle size distribution than prepared silica sand. For example, prepared silica sand may have a particle size ranging from about 100 to 400 μm, whereas unprocessed desert sand used in DSECC compositions of one or more embodiments may have an average particle size ranging from 200 to 600 μm when measured according to ASTM D6913. In one or more embodiments, DSECC compositions may include unprocessed desert sand having an average particle size ranging from a lower limit of one of 200, 250, 300, and 350 μm to an upper limit of one of 400, 450, 500, 550, and 600 μm, where any lower limit may be paired with any mathematically compatible upper limit.

Additionally, unprocessed desert sand used in DSECC compositions of one or more embodiments may have a less uniform particle size distribution than silica sand. DSECC compositions including desert sand having a relatively large particle size distribution may have a more compact microstructure than compositions including silica sand having a relatively smaller (narrow) particle size distribution.

In one or more embodiments, unprocessed desert sand has a distinct morphology compared to silica sand. For example, unprocessed desert sand included in DSECC compositions of one or more embodiments has a wider size distribution, a higher roundness, and a higher sphericity compared to silica sand, which has a narrower size distribution and more angular geometry as compared to desert sand.

Unprocessed desert sand included in DSECC compositions in accordance with the present disclosure may have a silica content different from silica sand. Typical manufactured silica sand may include at least 95% SiO₂, and more often includes about 99% SiO₂ with about 42% silicon and 57% oxygen. In contrast, unprocessed desert sand included in DSECC compositions according to the present disclosure may have an SiO₂ content of less than 90%, with a silicon content ranging from 25 to 35%, based on the total elemental content of the sand. For example, DSECC compositions may include unprocessed desert sand having a silicon content ranging from a lower limit of one of 25, 26, 27, 28, 29, and 30% to an upper limit of one of 30, 31, 32, 33, 34, and 35%, where any lower limit may be paired with any mathematically compatible upper limit. Additionally, unprocessed desert sand included in DSECC compositions of one or more embodiments includes varying amounts of other elements not included in silica sand such as, for example, calcium, iron, aluminum, and magnesium, among others.

DSECC compositions disclosed herein may include unprocessed desert sand in an amount ranging from 15 to 40 wt %, based on the total weight of the DSECC. For example, in one or more embodiments, DSECC compositions include unprocessed desert sand in an amount ranging from a lower limit of one of 15, 18, 20, 25, and 30 wt % to an upper limit of one of 30, 32, 35, 37, and 40 wt %, where any lower limit may be paired with any mathematically compatible upper limit.

In one or more embodiments, DSECC compositions include ash. For example, in some embodiments, DSECC compositions may include fly ash in an amount ranging from 15 to 45 wt %, based on the total weight of the DSECC. In one or more embodiments, fly ash is present in DSECC compositions in an amount ranging from a lower limit of one of 15, 20, and 30 wt % to an upper limit of one of 35, 40, and 45 wt %, where any lower limit may be paired with any mathematically compatible upper limit. Fly ash is a by-product of burning coal in power plants, and as such, is often readily available in locations where the primary energy source is coal burning. In one or more embodiments, DSECC compositions may include a combination of fly ash and silica fume.

In some embodiments, instead of including fly ash in DSECC compositions of the present disclosure, DSECC compositions may include volcanic ash, or a combination of volcanic ash and silica fume. Volcanic ash differs from fly ash in that volcanic ash is a naturally occurring pozzolanic material, that may be found in various dry, arid regions. Thus, the use of volcanic ash in the present DSECC compositions may reduce the carbon footprint and material cost of such DSECCs.

In one or more embodiments, DSECC compositions including a combination of ash and silica fume may have an amount of silica fume ranging from 4.0 to 9.0 wt %, based on the total weight of the DSECC. In one or more embodiments, silica fume is present in DSECC compositions in an amount ranging from a lower limit of one of 4.0, 4.5, 5.0, and 6.0 wt % to an upper limit of one of 6.0, 7.0, 8.0, and 9.0 wt %, where any lower limit may be paired with any mathematically compatible upper limit.

In one or more embodiments, DSECC compositions include a water reducer. Inclusion of a water reducer in DSECC compositions may decrease the water-cement ratio and water consumption while improving the hardening performance and strength of the DSECC. Any suitable water reducer known in the art may be added to disclosed DSECC compositions. Suitable water reducers include, but are not limited to, polycarboxylate water reducers, aliphatic water reducers, sulfamate water reducers, melamine-based water reducers, naphthalene-based water reducers, lignin-based water reducers, and combinations thereof. In particular embodiments, DSECC compositions include a polycarboxylate water reducer.

DSECC compositions may include a water reducer in an amount ranging from 0.05 to 1.1 wt %, based on the total weight of the DSECC. In one or more embodiments, for example, a water reducer may be present in a DSECC composition in an amount ranging from a lower limit of one of 0.05, 0.08, 0.1, 0.15, 0.2, and 0.25 wt % to an upper limit of one of 0.3, 0.5, 0.7, 0.8, 1.0, and 1.1 wt %, where any lower limit may be paired with any mathematically compatible upper limit.

In one or more embodiments, DSECC compositions include crumb rubber. Crumb rubber is an industrial byproduct from broken down rubber sources. In particular, crumb rubber may be provided from grinding rubber tires. Thus, inclusion of crumb rubber is another mechanism by which disclosed DSECC compositions may be made with a low carbon footprint and reduced material cost. In some embodiments, crumb rubber included in DSECC compositions may be produced cryogenically or by jet milling. Such crumb rubber may be superfine, i.e., have an average size ranging from 75 to 150 microns, or ultrafine, i.e., have an average size less than 75 microns. Incorporating superfine or ultrafine crumb rubber may result in increased dispersity of the crumb rubber particles in the DSECC composition.

Crumb rubber included in DSECC compositions of the present invention may include 6 to 20 wt % acetone extract, 0 to 10 wt % ash, 26 to 38 wt % carbon black, and 42 to 68 wt % rubber hydrocarbons. In one or more embodiments, the crumb rubber may be pre-treated with water in order to increase the workability and dispersion of the crumb rubber in the DSECC.

DSECC compositions may include crumb rubber in an amount ranging from 0.1 to 20 wt %, based on the total weight of the DSECC. For example, crumb rubber may be included in a DSECC composition of one of more embodiments in an amount ranging from a lower limit of one of 0.1, 0.5, 1.0, 2.0, 5.0, 7.5, and 10 wt % to an upper limit of one of 5, 10, 15, 18, and 20 wt %, where any lower limit may be paired with any mathematically compatible upper limit.

Powdered ingredients of DSECC compositions may be mixed with water to form a slurry, where the slurry may be formed to a pipe shape and cured to make a pipe. In one or more embodiments, water may be included in an amount ranging from 5 to 20 wt %.

In one or more embodiments, DSECC compositions include various other additives. Suitable additives that may be included in DSECC compositions according to the present disclosure include, but are not limited to, crystalline capillary waterproofing admixtures (such as Master Life® 300D supplied by BASF), carbon black, oil ash, calcium hydroxide, cement kiln dust, bag house dust, recycled plastic, silicates, oxides, belite (Ca₂SiO₅), alite (Ca₃SiO₄), tricalcium aluminate (Ca₃Al₂O₆), tetracalcium aluminoferrite (Ca₄Al₂Fe₂O₁₀), brownmilleriate (4CaOAl₂O₃· Fe₂O₃), gypsum (CaO₄·2H₂O), sodium oxide, potassium oxide, limestone, lime (calcium oxide), hexavalent chromium, calcium aluminate, hematite, manganese tetroxide, and combinations thereof. The DSECC composition may also include additives such as siliceous fly ash, calcareous fly ash, blast furnace slag, slag cement, quartz, any known cement binder material and combinations thereof.

Additionally, DSECC compositions according to embodiments of the present disclosure may be made entirely without viscosity reducers.

### DSECC Properties

DSECCs in accordance with the present disclosure may have improved mechanical properties, such as, for example, ductility, stiffness, and tensile strain, as compared to conventional ECCs and other concretes that allows DSECC compositions according to the present disclosure to be used to build fully non-metallic pipes. Ductility may be defined by the degree to which a material can sustain deformation under a tensile stress before failure. As such, the ductility of DSECC compositions may also be referred to as the tensile strain capacity.

In one or more embodiments, DSECCs have a tensile strain capacity ranging from 8.0 to 12.5%. For example, DSECCs in accordance with the present disclosure have a tensile strain capacity ranging from a lower limit of one of 8.0, 8.5, 9.0, 9.0, and 10% to an upper limit of one of 10, 10.5, 11, 11.5, 12, and 12.5%, where any lower limit may be paired with any mathematically compatible upper limit. In comparison, typical ECCs have a tensile strain capacity ranging from 3.0 to 7.0%, and conventional concretes have a tensile strain capacity of about 0.03%, as measured according to ASTM C307 “Standard Test Method for Tensile Strength of Chemical-Resistant Mortar, Grouts, and Monolithic Surfacings.”

In one or more embodiments, DSECC compositions have improved tensile strength compared to conventional ECCs and other concretes. For example, DSECCs of the present disclosure may have a tensile strength ranging from 8.0 to 13.5 MPa. DSECCs of one or more embodiments may have a tensile strength ranging from a lower limit of one of 8.0, 9.0, 10.0, and 11.0 MPa, to an upper limit of one of 12.0, 12.5, 13.0, and 13.5 MPa, where any lower limit may be paired with any mathematically compatible upper limit. In comparison, typical ECCs may have a tensile strength ranging from about 4.0 to about 6.0 MPa, as measured according to ASTM C307 “Standard Test Method for Tensile Strength of Chemical-Resistant Mortar, Grouts, and Monolithic Surfacings.”

Table 1, below, shows examples of DSECC compositions according to embodiments of the present disclose compared with a reference ECC material. In Table 1, the components are measured in kg/m₃.

TABLE 1

| Mixture | OPC | FA | SF | F75 | DS | CR | W | WR | PVA | PE | PP |
|---|---|---|---|---|---|---|---|---|---|---|---|
| Ref | 400 | 880 | 0 | 460 | 0 | 0 | 346 | 2 | 26 | 0 | 0 |
| DSECC 1 | 400 | 880 | 0 | 0 | 384 | 30 | 346 | 2 | 0 | 10 | 9 |
| DSECC 2 | 340 | 748 | 0 | 0 | 653 | 30 | 294 | 2 | 0 | 10 | 9 |
| DSECC 3 | 800 | 400 | 150 | 0 | 405 | 0 | 189 | 20 | 0 | 20 | 0 |
| DSECC 4 | 650 | 325 | 120 | 0 | 657 | 0 | 153 | 20 | 0 | 20 | 0 |

OPC = Ordinary Portland cement;
FA = fly ash;
SF = silica fume;
DS = desert sand;
CR = crumb rubber;
W = water;
WR = water reducer;
PE = polyethylene fiber;
PP = polypropylene fiber;
PVA = polyvinyl alcohol fiber;
F75 = a manufactured silica sand with average diameter of 110 μm

As shown in Table 1, the reference ECC composition was made with PVA rather than PE or PP and premade silica sand rather than desert sand. The DSECC samples made according to embodiments of the present disclosure included various ingredient proportions of OPC, fly ash, combinations of silica fume, PP, and PE, and crumb rubber to try to maintain strain-hardening behavior when different amounts of desert sand are used.

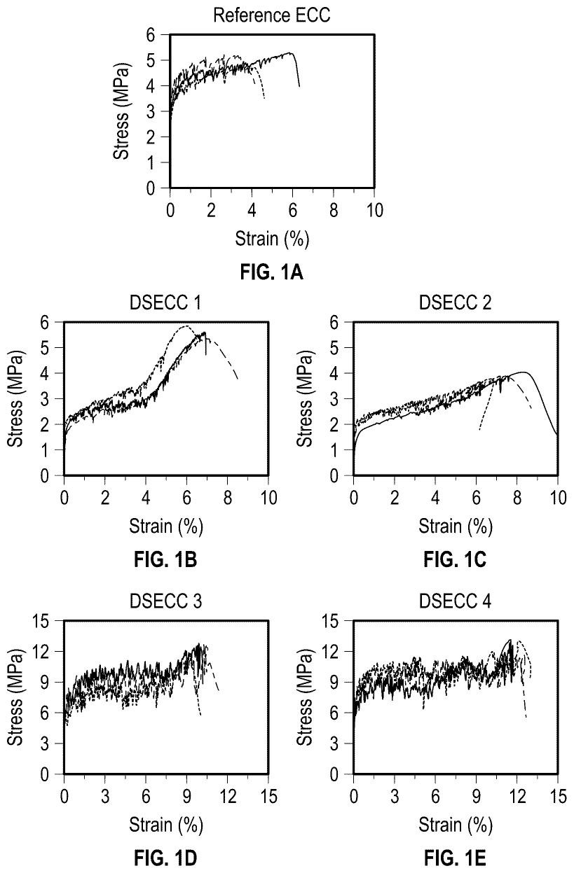

FIGS. 1A-1E show the tensile strain-hardening behavior of the reference ECC and DSECC samples 1-4 from Table 1, where each line on each graph represents a different specimen. As shown, the DSECC compositions according to embodiments of the present disclosure (DSECC samples 1-4, represented in FIGS. 1B-E) showed greater tensile strength when compared to the tensile strength of the reference ECC (FIG. 1A).

As discussed above, the DSECC samples could also be made by replacing the fly ash with volcanic ash or with a mixture of volcanic ash and silica fume. Additionally, the DSECC samples could also be modified to include recycled materials as a partial replacement of the cementitious materials and desert sand, such as partial replacement of one or more of cement kiln dust, oil ash, limestone powder, blast furnace slag, bag house dust, and recycled plastic.

### DSECC Pipes

DSECC compositions described herein may be used to form pipes without reinforcement members. For example, DSECC pipes according to embodiments of the present disclosure may be used as pipes in the infrastructure in oil and gas facilities including, but not limited to, water pipes, waste pipes, etc. or any other application where RCP would otherwise be used.

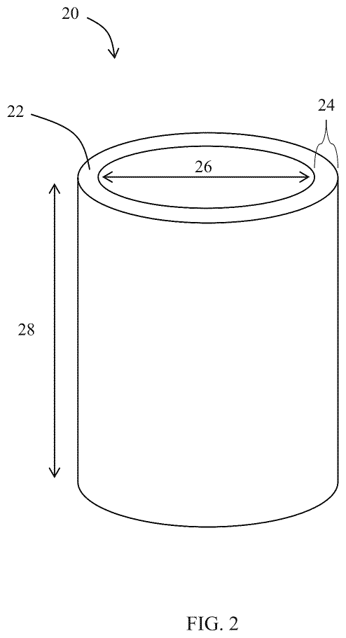

FIG. 2 shows an example of a DSECC pipe 20 according to embodiments of the present disclosure. The DSECC pipe 20 has a tubular body 22 made entirely of a DSECC composition according to embodiments of the present disclosure, including a cement binder, unprocessed desert sand, and polymer fibers selected from PE fibers, PP fibers, and a combination thereof. For example, in one or more embodiments, the DSECC composition forming the pipe 20 may include, for example, a cement binder (e.g., OPC) in an amount ranging from 390 to 410 kg/m3 of the DSECC; fly ash in an amount ranging from 800 to 900 kg/m3 of the DSECC; unprocessed desert sand in an amount ranging from 380 to 390 kg/m3 of the DSECC; crumb rubber in an amount ranging from 25 to 35 kg/m3 of the DSECC; a water reducer in an amount less than 10 kg/m3 of the DSECC; polymer fibers (e.g., PE fibers, PP fibers, or a combination thereof), wherein the polymer fibers are between 15 and 25 kg/m3 of the DSECC; and water forming a remaining amount of the DSECC. Such DSECC may have a tensile strength ranging between 11 and 13 MPa and a ductility ranging between 8 and 13 percent.

By forming the DSECC pipe 20 entirely of DSECC material according to embodiments of the present disclosure, the DSECC pipe 20 is made without a metallic reinforcement member (e.g., without a steel frame or rebars) and without pultruded reinforcement such as GFRP rebars and is entirely made with non-metallic fiber.

The tubular body 22 has a wall with a reduced thickness 24 compared with conventional RCP. For example, in one or more embodiments, the wall thickness may be less than 22 percent of an inner diameter 26 of the DSECC pipe 20.

The DSECC pipe 20 may be made in sections having various lengths 28. For example, the DSECC may have the same length 28 as standard pipe section lengths for conventional RCP pipe, such as ranging from 8 ft to 12 ft.

Additionally, DSECC pipe 20 according to embodiments of the present disclosure may have a joint connection formed at one or both axial ends of the pipe segment. The joint connections formed at the axial end(s) of the pipe segment may have one or more interlocking features (e.g., tongue and groove features or lip and shoulder features), such that the joint connection at an axial end of a first pipe segment may be mated with a corresponding joint connection at an axial end of a second pipe segment. In such manner, DSECC pipe segments having corresponding interconnecting joint types at opposite axial ends may be interconnected together in an end-to-end fashion.

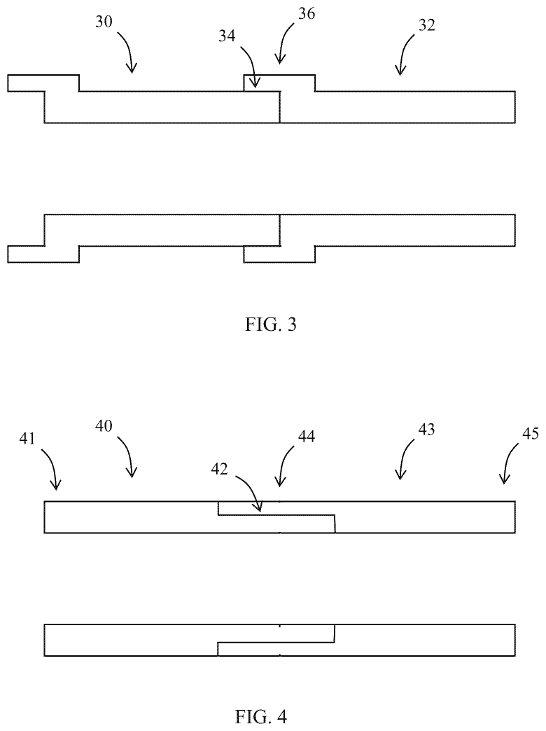

For example, FIG. 3 shows an example of a first DSECC pipe segment 30 connected to a second DSECC pipe segment 32 at their axial ends, where FIG. 3 is a cross-sectional view of the pipe connection taken along the axial length of the pipes 30, 32. The first and second DSECC pipes segments 30, 32 each have a generally tubular-shaped body with a flow path formed axially therethrough. The first DSECC pipe 30 has a first joint type formed at its first axial end 34, and the second DSECC pipe 32 has a second joint type formed at its second axial end 36, where the second joint type of the second axial end of the second DSECC pipe 32 interconnects (and mates) with the first joint type of the first axial end 34 of the first DSECC pipe 30. In the embodiment shown, the first joint type has a shape and thickness uniform with the tubular body wall, whereas the second joint type has a collar that is shaped and sized to fit around and mate with the first joint type. In one or more embodiments, a collar joint type may have an outer diameter greater than the outer diameter of the tubular body (extending between the axial end joint types) and an inner diameter greater than the inner diameter of the tubular body, where a stepped or transitioned profile is formed between the collar joint and the tubular body.

In one or more embodiments, the first and second DSECC pipe segments 30, 32 may have the same shape and size, where the first axial ends of both the first and second DSECC pipe segments 30, 32 have the same joint type, and the second axial ends of both the first and second DSECC pipe segments 30, 32 have the same joint type. In other embodiments, connecting DSECC pipe segments may have different axial end geometries (e.g., when one of the connected pipes is a terminal DSECC pipe). In some embodiments, a same joint type may be formed at both axial ends of a DSECC pipe segment.

FIG. 4 shows another example of a DSECC pipe connection, where FIG. 4 is a cross-sectional view taken along the axial length of the pipes. As shown, a first DSECC pipe 40 has a first axial end 41 and an opposite, second axial end 42, and a second DSECC pipe 43 has a first axial end 44 and an opposite, second axial end 45. The second axial end 42 of the first DSECC pipe 40 has a joint type that corresponds with and mates with the joint type formed at the first axial end 44 of the second DSECC pipe 43. In the embodiment shown, the mating second and first axial ends 42, 44 each have a lip profile that mate with each other such that a uniform inner diameter and/or outer diameter may be maintained between the DSECC pipes 40, 43 and pipe connection.

In one or more embodiments, joint types formed at an axial end of DSECC pipe according to embodiments of the present disclosure may be selected from joint types commonly used for RCP pipe such as, for example, rigid spigot and socket joints, rigid collar joints, and internal and external flush joints.

In some embodiments, a DSECC pipe may be an end or terminal pipe segment. In some embodiments, a DSECC pipe may be formed in a geometry to have a 3-way connection. For example, a DSECC pipe may have a T-shaped body. In such embodiments, the DSECC T-shaped pipe may have three flow path openings, which may have the same or different joint types formed at each opening.

In one or more embodiments, DSECC pipe may be formed by filling a mold with a DSECC composition according to embodiments of the present disclosure and allowing the DSECC composition to cure before removing the mold. The mold may be filled entirely with the DSECC composition, without providing a reinforcement member (e.g., a steel frame) in the mold. The DSECC composition may be prepared prior to filling the mold by mixing the ingredients of the DSECC composition in a mixer.

By using DSECC compositions according to embodiments of the present disclosure to form pipes without reinforcement members, DSECC pipes may be made with significantly thinner pipe walls and lighter weight without sacrificing pipe longevity and performance.

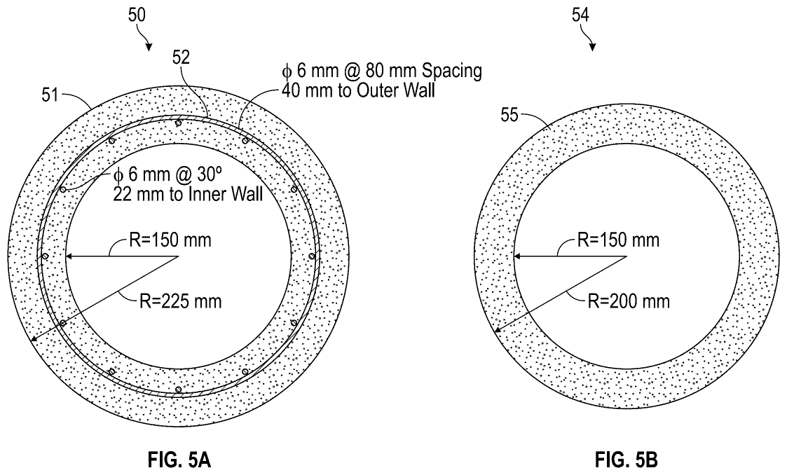

For example, FIGS. 5A and 5B show a comparison of a conventional RCP and a DSECC pipe according to embodiments of the present disclosure, respectively. Particularly, FIGS. 5A and 5B show a cross-sectional view of the pipes taken along a radial plane perpendicular to pipe's axial length. The cross-section may be taken along the length of the pipes between the axial ends of the pipes.

As shown in FIG. 5A, the conventional RCP 50 has a cylindrical wall 51 having an inner diameter of 300 mm, an outer diameter of 450 mm, and a uniform thickness of 75 mm, where a steel reinforcement member 52 is embedded within the thickness of the wall 51. Relatively greater thickness of the wall 51 of the conventional RCP may be designed to provide a sufficient amount of concrete on either side of the steel reinforcement member 52 to prevent cracking, chipping, or other degradation around the reinforcement member 52.

As shown in FIG. 5B, the DSECC pipe 54 has a cylindrical wall 55 having an inner diameter of 300 mm, an outer diameter of 400 mm, and a uniform thickness of 50 mm. The entire thickness of the wall 55 is formed of a DSECC composition according to embodiments of the present disclosure, without a reinforcement member. Due to the improved strength of the DSECC composition, the DSECC pipe 54 may be formed without a reinforcement member and having a reduced wall thickness. In the comparison example shown in FIGS. 5A and 5B, the DSECC pipe 54 may have a reduced wall thickness of about 16.7% of the inner diameter of the pipe, whereas the conventional RCP pipe 50 having the same inner diameter has a wall thickness of about 25% of the inner diameter. Thus, the DSECC pipe 54 may have a 33% reduction in wall thickness from a conventional RCP pipe 50 with the same inner diameter.

In one or more embodiments, DSECC pipes according to embodiments of the present disclosure may have a reduced wall thickness when compared to a conventional RCP pipe that is reduced by more than 10%, more than 25%, or more than 33%, e.g., up to 50%. For example, in one or more embodiments, a DSECC pipe may have a wall thickness that is less than 22% of the inner diameter defined between the wall. In one or more embodiments, a DSECC pipe may have a wall thickness ranging from an upper limit of 22%, 20%, or 15% of the inner diameter to a lower limit of 18%, 14%, 8%, or 5% of the inner diameter, wherein any upper limit may be paired with any mathematically compatible lower limit.

In embodiments where a DSECC pipe has a non-circular radial cross-section shape, the DSECC pipe may have a wall thickness that is less than 22% (e.g., ranging from 5 to 22%) of the smallest inner diameter measured between the wall.

In addition to being able to form concrete pipe with a relatively thinner wall thickness and no reinforcement member, DSECC pipe according to embodiments of the present disclosure may also have improved strength when compared with conventional RCP pipe.

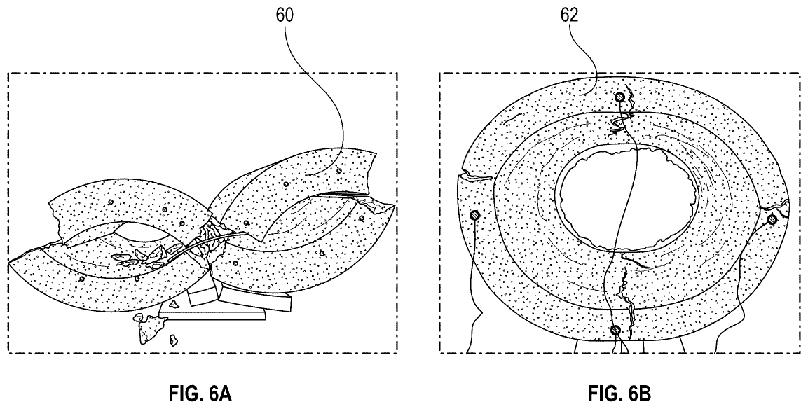

For example, FIGS. 6A and 6B show an example of a loading test comparing the structural resiliency of a conventional RCP pipe 60 compared to a DSECC pipe 62 according to embodiments of the present disclosure having the same inner diameters. In FIGS. 6A and 6B, the four dots are part of an OPTOTRAK sensing system to monitor the pipe wall deformation without contact during load. In the comparison loading test, the pipes 60, 62 were loaded in a 3-point crushing method in a load frame, according to ASTM C497. From the test loading, there was a total collapse of the RCP pipe 60, despite the presence of steel reinforcement and a relatively larger wall thickness. Particularly, the RCP pipe 60 collapsed into four quarters. In contrast, the DSECC pipe 62 deformed into an oval shape, but maintained its structural integrity and remained intact after the test loading.

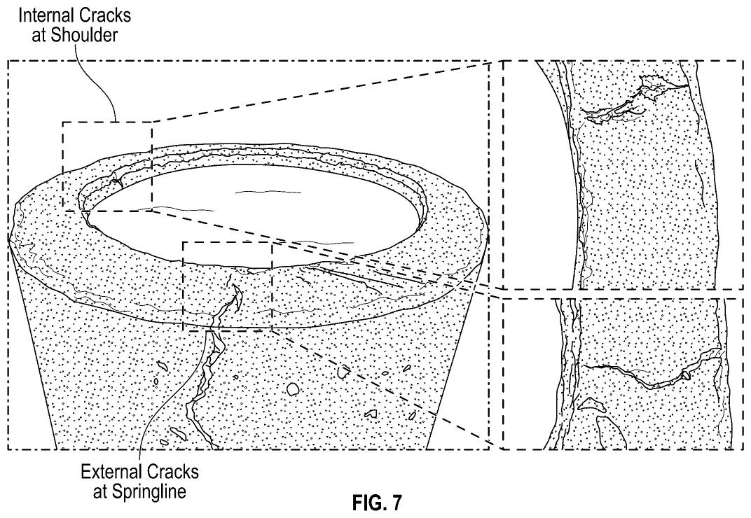

After the loading test, the DSECC pipe 62 (deformed into an oval radial cross-section shape) was filled with water to test leakage from the pipe after deformation, as shown in FIG. 7. Although the deformed DSECC pipe 62 had cracks formed during the loading test, no water leaked from the pipe when the deformed DSECC pipe 62 was filled with water because the cracks were controlled and did not penetrate through the entire thickness of the pipe wall. Thus, the water-fill test demonstrated the leak-proof functional enhancement of DSECC pipe 62, even after the pipe has been loaded into an oval shape.

Given the higher resiliency to extreme loading, DSECC pipe according to embodiments of the present disclosure is safer than conventional RCP in resisting large loads such as earthquake, blast, or other forms of accidental overload. Additionally, the reduced wall thickness afforded by DSECC pipe provides a reduction in material volume and cost savings over conventional RCP. For example, cost-savings amounting to 50% over conventional RCP manufacturing can be attained, especially when the cost of reinforcing steel is accounted for. Further, DSECC pipes according to embodiments of the present disclosure are fully non-metallic pipes with stiffness much higher than that of polymeric pipes such as PVC pipes and do not corrode as in steel pipes.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A pipe, comprising:
a tubular body made entirely of a desert sand engineered cementitious composite (DSECC),
comprising:
a cement binder;
unprocessed desert sand; and
polymer fibers selected from the group consisting of polyethylene fibers,
polypropylene fibers, and a combination thereof;
wherein the tubular body has a wall with a thickness that is less than 22 percent of an inner diameter of the pipe; and
wherein the pipe is non-metallic.

2. The pipe of claim 1, wherein the DSECC has a tensile strength of at least 12 MPa and a ductility of at least 12%.

3. The pipe of claim 1, wherein the cement binder is ordinary Portland cement.

4. The pipe of claim 1, wherein the DSECC further comprises fly ash.

5. The pipe of claim 1, wherein the DSECC further comprises volcanic ash.

6. The pipe of claim 1, wherein the DSECC further comprises silica fume.

7. The pipe of claim 1, wherein the DSECC further comprises crumb rubber.

8. The pipe of claim 1, wherein the DSECC further comprises a water reducer.

9. A desert sand engineered cementitious composite (DSECC), comprising:
a cement binder in an amount ranging from 390 to 410 kg/m³ of the DSECC;
fly ash in an amount ranging from 800 to 900 kg/m³ of the DSECC;
unprocessed desert sand in an amount ranging from 380 to 390 kg/m³ of the DSECC;
crumb rubber in an amount ranging from 25 to 35 kg/m³ of the DSECC;
a water reducer in an amount less than 10 kg/m³ of the DSECC;
polymer fibers selected from the group consisting of polyethylene fibers, polypropylene fibers, and a combination thereof,
wherein the polymer fibers are between 15 and 25 kg/m3 of the DSECC; and
water forming a remaining amount of the DSECC.

10. The ECC of claim 9, wherein the DSECC is free of viscosity reducers.

11. The ECC of claim 9, wherein the cement is ordinary Portland cement.

12. The ECC of claim 9, wherein the DSECC has a tensile strength ranging between 11 and 13 MPa and a ductility ranging between 8 and 13 percent.
